(19) United States
(12) Patent Application Publication
(10) Pub. No.: US 2015/0041022 A1
(43) Pub. Date: Feb. 12, 2015

(54) METHOD FOR PRODUCING NDFEB SYSTEM SINTERED MAGNET

(71) Applicant: INTERMETALLICS CO., LTD., Kyoto-shi, Kyoto (JP)

(72) Inventors: Kazuyuki Komura, Kyoto-shi (JP); Tetsuhiko Mizoguchi, Kyoto-shi (JP); Masato Sagawa, Kyoto-shi (JP)

(21) Appl. No.: 14/354,823

(22) PCT Filed: Oct. 17, 2012
(86) PCT No.: PCT/JP2012/076797

§ 371 Date: Apr. 28, 2014

(30) Foreign Application Priority Data
Oct. 27, 2011 (JP) 2011-235571

(51) Int. Cl. H01F 41/02; C21D 9/46; H01F 1/053

(52) U.S. Cl. CPC H01F 41/0293; H01F 1/053; H01F 41/0253; C21D 9/46
USPC 148/102; 427/127

(57) ABSTRACT

A method for producing a NdFeB system sintered magnet in which a coating material containing a heavy rare-earth element R_{H} applied to a base material of a NdFeB system sintered magnet is inexpensively prevented from adhering to a tray or similar device in a grain boundary diffusion treatment. The method includes the steps of applying a coating material containing a heavy rare-earth element R_{H} to a base material and diffusing the element through grain boundaries in the base material by a grain boundary diffusion method. The coating material is applied to a sheet. The sheet is made to come in tight contact with the base material so that the coating material applied to the sheet contacts an application target surface of the base material. With the sheet held in tight contact with the base material, the grain boundary diffusion treatment (heat treatment) is performed on the base material.

### TECHNICAL FIELD

The present invention relates to a method for producing a NdFeB (neodymium-iron-boron) system sintered magnet, and more specifically, to a method for producing a NdFeB system sintered magnet using a grain boundary diffusion method. A “NdFeB system (sintered) magnet” is a (sintered) magnet containing Nd₂Fe₁₄B as the main phase. However, the magnet is not limited to the magnet which contains only Nd, Fe and B; it may additionally contain a rare-earth element other than Nd as well as other elements, such as Co, Ni, Cu or Al.

### BACKGROUND ART

NdFeB system sintered magnets were discovered by Sagawa (one of the present inventors) and other researchers in 1982. The magnets exhibit characteristics far better than those of conventional permanent magnets and can be advantageously manufactured from Nd (a kind of rare-earth element), iron and boron, which are relatively abundant and inexpensive materials. Hence, NdFeB system sintered magnets are used in a variety of products, such as driving motors for hybrid or electric cars, battery-assisted bicycle motors, industrial motors, voice coil motors used in hard disks and other apparatuses, high-grade speakers, headphones, and permanent magnetic resonance imaging systems. NdFeB system sintered magnets used for those purposes must have a high coercive force H_{eJ}, a high maximum energy product (BH)ₘₐₓ, and a high squareness ratio SQ. The squareness ratio SQ is defined as the ratio of the magnetic field (Hₖ) to the coercive force (H_{cJ}), i.e. Hₖ/H_{cJ}, at the point corresponding to 90% of the residual magnetic flux Bᵣ in the second quadrant of the magnetization curve.

One method for enhancing the coercive force of a NdFeB system sintered magnet is a “single alloy method”, in which Dy and/or Tb (the “Dy and/or Tb” is hereinafter represented by “R_{H}”), both of which are heavy rare-earth elements, is added to a starting alloy when preparing the alloy. Another method is a “binary alloy blending technique”, in which a main phase alloy which does not contain R_{H} and a grain boundary phase alloy to which R_{H} is added are prepared as two kinds of starting alloy powder, which are subsequently mixed together and sintered. Still another method is a “grain boundary diffusion method”, which includes the steps of creating a NdFeB system sintered magnet as a base material, applying a coating material containing R_{H} to the surface of the base material, and heating the base material together with the coating material to diffuse R_{H} from the surface of the base material into the inner region through the boundaries inside the base material (Patent Literature 1).

The coercive force of a NdFeB system sintered magnet can be enhanced by any of the aforementioned methods. However, it is known that the maximum energy product decreases if R_{H} is present in the main-phase grains inside the sintered magnet. In the case of the single alloy method, since R_{H} is mixed in the main-phase grains at the stage of the starting alloy, a sintered magnet created from this alloy inevitably contains R_{H} in its main-phase grains. Therefore, the sintered magnet created by the single alloy method has a relatively low maximum energy product while it has a high coercive force.

In the case of the binary alloy blending technique, the largest portion of R_{H} will be held in the boundaries between the main-phase grains. Therefore, as compared to the single alloy method, the technique can reduce the amount of decrease in the maximum energy product. Another advantage over the single alloy method is that the amount of the rare metal used, i.e. R_{H}, is reduced.

In the case of the grain boundary diffusion method, R_{H} attached to the surface of the base material is diffused into the inner region through the boundaries liquefied by heat in the base material. Therefore, the diffusion rate of R_{H} in the boundaries is much higher than the rate at which R_{H} is diffused from the boundaries into the main-phase grains, so that R_{H} is promptly supplied into deeper regions of the base material. By contrast, the diffusion rate from the boundaries into the main-phase grains is low, since the main-phase grains remain in the solid state. Using this difference in the diffusion, the temperature and time of the heating process can be regulated so as to realize an ideal state in which the Dy or Tb concentration is high only in the vicinity of the surface of the main-phase grains (grain boundaries) in the sintered body while the same concentration is low inside the main-phase grains. Thus, it is possible to make the amount of decrease in the maximum energy product (BH)ₘₐₓ smaller than in the case of the binary alloy blending technique while enhancing the coercive force H_{c}). Another advantage over the binary alloy blending technique is that the amount of the rare metal used, i.e. R_{H}, is reduced.

### CITATION LIST

### Patent Literature

Patent Literature 1: WO 2006/043348
Patent Literature 2: WO 2008/139690

### SUMMARY OF INVENTION

### Technical Problem

One problem of the grain boundary diffusion method is that the treatment after the application of the coating material is difficult. After the coating material is applied, the base material is placed on a tray or similar predetermined device, to be heated in a furnace. If the base material has the coating material applied to the contact surface at which the base material comes in contact with the tray, the coating material will adhere to the tray when heated.

If the coating material adheres to the tray, a cumbersome task for removing the adhered material (e.g. polishing the tray) is additionally required before the tray is reused. Furthermore, the adhesion causes a corresponding decrease in the amount of R_{H} available for the grain boundary diffusion on the contact surface between the base material and the tray, which lowers the performance of the produced magnet per unit amount of R_{H} used. It also means wasting the rare and expensive material R_{H}.

The present invention has been developed to solve the previously described problem, and its primary objective is to provide a method for producing a NdFeB system sintered magnet in which a coating material containing R_{H} or R_{H} compound applied to a base material of a NdFeB system sintered magnet is inexpensively prevented from adhering to a tray or similar device in a grain boundary diffusion treatment.

Another objective of the present invention is to provide a method for producing a NdFeB system sintered magnet in which the quantity of the costing material applied for the grain boundary diffusion treatment can be easily regulated and which is suitable for mass production.

### Solution to Problem

The present invention aimed at solving the previously described problem is a method for producing a NdFeB system sintered magnet including a grain boundary diffusion treatment process in which, after a coating material containing a heavy rare-earth element is applied to a base material of a NdFeB system sintered magnet, the base material with the coating material applied is heated so as to diffuse the heavy rare-earth element in the coating material through grain boundaries into the base material, the method including the steps of:

applying the coating material to a sheet;

making the sheet come in tight contact with the base material in such a manner that the coating material applied to the sheet comes in contact with an application target surface of the base material; and

performing the grain boundary diffusion treatment by heating the base material together with the sheet.

As the coating material, a powder of metal or alloy containing a heavy rare-earth element R_{H}, or a paste or slurry prepared by dispersing this powder in water or a viscous material, is available. Examples of the powder include an alloy powder of an iron-group transition metal with an R_{H} content of 50 wt % or higher, a powder of pure metal composed of only R_{H}, and a powder of hydride of such alloy or pure metal. A mixture of a powder of R_{H} fluoride or oxide and an aluminum powder may also be used, as described in Patent Literature 2. Examples of the viscous material include liquid paraffin, silicon grease and other materials which have appropriate degrees of viscosity while being easily volatilized and barely absorbed by the base material during the grain boundary diffusion treatment. The “viscous material having an appropriate degree of viscosity” is a material whose viscosity is equal to or higher than that of water (˜1 mPa·sec) as well as equal to or lower than that of solder paste (˜500 Pa·sec). Within this viscosity range, the powder can be uniformly dispersed in the viscous material when mixed in this material, and simultaneously, the viscous material in which the powder has been mixed can have a sufficient degree of fluidity for application to the sheet.

In the method for producing a NdFeB system sintered magnet according to the present invention, the surface of the base material to which the coating material is to be applied (“application target surface”) is covered with a sheet. This sheet prevents the coating material applied to the base material from coming in contact with a tray or similar device, and from adhering to the device due to the grain boundary diffusion treatment.

A number of hollow portions may preferably be provided on the application surface of the sheet so that the coating material will be held in the hollow portions by making the sheet be in tight contact with the base material. By this configuration, the coating material can be evenly distributed on the application target surface of the base material. Furthermore, the amount of coating material can be easily regulated through the number and/or depth of the hollow portions.

To improve the use efficiency in the base material of the heavy rare-earth element contained in the coating material applied to the sheet, the sheet should preferably be made of a material in which the heavy rare-earth element is less diffusive than in the base material.

Furthermore, the sheet should preferably be made of a material whose chemical or physical change during the grain boundary diffusion treatment is insignificant and does not affect the performance of the produced NdFeB system sintered magnet.

The sheet should preferably be a graphite sheet (a flexible graphite sheet produced by graphite-molding). In the grain boundary diffusion treatment, the temperature is increased to as high as 900 degrees Celsius. However, since the treatment is performed in an inert-gas atmosphere, vacuum atmosphere or oxygen-free atmosphere in order to prevent oxidation of the base material, the graphite sheet will neither burn nor deform even if it is heated to the aforementioned temperature. Furthermore, the graphite sheet hardly reacts with the base material or the coating material. Diffusion of the heavy rare-earth element from the coating material into the graphite sheet also hardly occurs. The graphite sheet is suitable as the sheet material for many other reasons, such as the commercial availability, high workability, and inexpensiveness. Replacing an unusably worn-out graphite sheet is also easy.

Various experiments conducted by the present inventor have demonstrated that the coating material may possibly be detached from the base material in the course of the grain boundary diffusion treatment depending on the viscosity of the coating material. To prevent this situation, pressure should preferably be applied to the sheet during the grain boundary diffusion treatment so as to increase the degree of contact between the base material and the coating material.

The sheet may entirely cover the surfaces on the same side of a plurality of horizontally arranged base materials. It is also possible to vertically stack a plurality of base materials while covering each of the upper and lower surfaces of each base material with the sheet. As explained earlier, in the method for producing a NdFeB system sintered magnet according to the present invention, it is preferable to apply pressure on the sheet during the grain boundary diffusion treatment. When a plurality of base materials are vertically stacked in the aforementioned manner, the weight of the base materials on the upper levels produces a natural pressure acting on the sheets on the lower levels. Pressure application to the sheet on the uppermost level can be achieved, for example, by putting an additional weight on the top.

### Advantageous Effects of the Invention

In the method for producing a NdFeB system sintered magnet according to the present invention, since the application surface of the base material is covered with the sheet, the coating material applied to the base material is prevented from adhering to a tray or the like in the grain boundary diffusion treatment. Providing the sheet with hollow portions on the application surface enables easy control of the amount of coating material. Using the technique of entirely covering a plurality of base material with the sheet, or of vertically stacking a plurality of base materials with the sheet in between, makes the present invention suitable for mass production.

### BRIEF DESCRIPTION OF DRAWINGS

FIGS. 1A-1D are vertical sectional views for explaining one embodiment of the method for producing a NdFeB system sintered magnet using a grain boundary diffusion method according to the present invention.

FIGS. 2A-2C are vertical sectional views for explaining conventional methods for producing a NdFeB system sintered magnet using a grain boundary diffusion method.

FIGS. 3A-3D are vertical sectional views showing examples of the placement of the base material and the sheet in the method for producing a NdFeB system sintered magnet according to the present embodiment.

FIGS. 4A and 4B are diagrams showing one example of the sheet used in the method for producing a NdFeB system sintered magnet according to the present embodiment.

FIG. 5 is a vertical sectional view of one example of the process of preparing a sheet having hollow portions formed on the application surface.

FIGS. 6A and 6B are vertical sectional views showing an application example of the sheet having the hollow portions formed on the application surface in the method for producing a NdFeB system sintered magnet according to the present embodiment.

### DESCRIPTION OF EMBODIMENTS

### Example

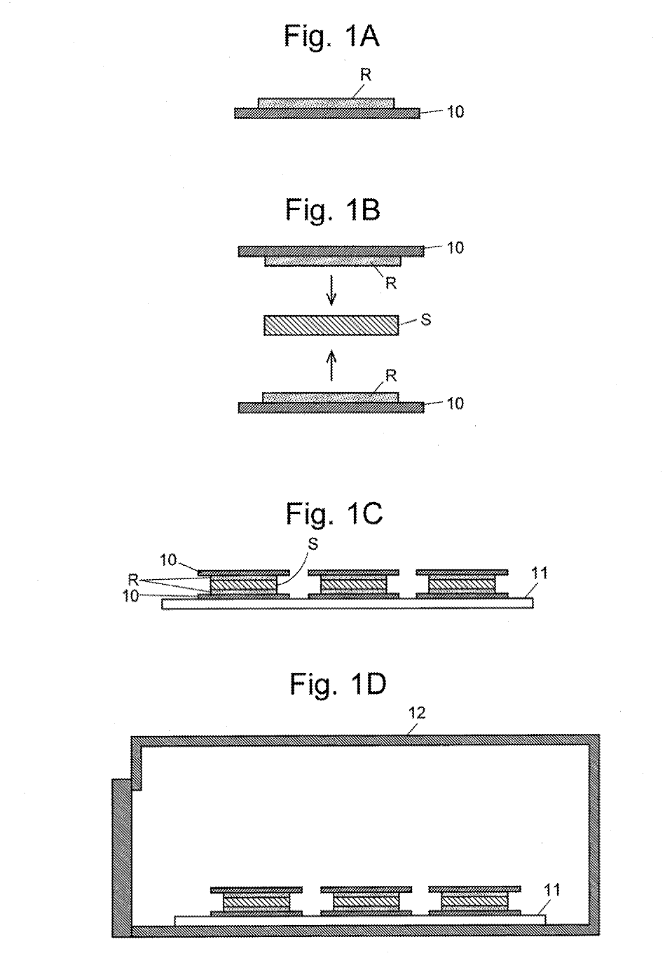

One example of the method for producing a NdFeB system sintered magnet using the grain boundary diffusion method according to the present invention is hereinafter described with reference to FIGS. 1A-6B. The method for manufacturing a base material for the NdFeB system sintered magnet is not particularly limited in the present invention. For example, a method disclosed in JP 2006-019521 A can be used, in which case a base material with high magnetic properties can be produced in a near-net shape.

FIGS. 1A-1D are explanatory diagrams showing the method for producing a NdFeB system sintered magnet according to the present embodiment. As shown, in the method for producing a NdFeB system sintered magnet according to the present embodiment, a sheet 10 made of a material which does not undergo chemical or physical changes during the grain boundary diffusion treatment (which will be described later), with a paste-like coating material R containing R_{H} evenly applied on one side, is prepared (FIG. 1A).

The coating material R is a paste composed of a powder of metal or alloy with an R_{H} content of 50 wt % or higher (which is hereinafter called the “R_{H} powder”) mixed with a viscous material. Silicon grease, liquid paraffin or the like is used as the viscous material. When silicon grease is adopted as the viscous material, it is possible to mix silicon oil or the like to effectively control its viscosity.

In the present embodiment, a powder of TbNiAl alloy composed of 92 wt % of Tb, 4.3 wt % of Ni and 3.7 wt % of Al is used as the R_{H} powder. Naturally, Dy or another heavy rare-earth element can be used instead of Tb. Provided that the amount of R_{H} powder applied to the surface of the base material S is the same, using a powder with a smaller grain size leads to a more uniform grain distribution and hence a more stable improvement in the magnetic properties through the grain boundary distribution treatment. This means that the grain size of the R_{H} powder should preferably be as small as possible. However, decreasing the grain size increases the time, labor and cost for pulverization. In view of such time, labor and cost for the pulverization, the grain size of the R_{H} powder should preferably be 2 μm or larger. Furthermore, in view of the magnetic properties after the grain boundary diffusion treatment and the uniformity in the grain distribution, the upper limit of the grain size of the R_{H} powder is 100 μm, preferably 50 nm, and more preferably 20 μm.

The mixture ratio by weight of R_{H} powder and silicon grease can be arbitrarily selected so as to adjust the paste viscosity to a desired level. However, a lower percentage of R_{H} powder leads to a smaller amount of this powder penetrating into the base material in the grain boundary diffusion treatment. Given this fact, the percentage of R_{H} powder should be 80 wt % or higher, preferably 85 wt % or higher, and more preferably 90 wt % or higher. Reducing the percentage of silicon grease to less than 5 wt % leads to inadequate mixture with the R_{H} powder and prevents preparation of a paste which can be easily applied to the sheet. Accordingly, the percentage of silicon grease should preferably be 5 wt % or higher. The mixture ratio of silicon oil or the like for viscosity control can be increased to approximately 15%, which, however, lowers the percentage of R_{H} powder and hence decreases the amount of R_{H} powder penetrating into the base material in the grain boundary diffusion treatment. Accordingly, the percentage should ideally be 5 wt % or lower.

The application surface of the sheet 10 is directed to, and made to be in tight contact with, the application target surface (the upper and lower surfaces of the base material S) of the base material S, as shown in FIG. 1B. Subsequently, the base material S covered with the sheets 10 is placed on a tray 11 (FIG. 1C) and put into a furnace 12, in which the base material S together with the sheets 10 are subjected to a heat treatment (grain boundary diffusion treatment) in an inert-gas atmosphere or oxygen-free atmosphere (FIG. 1D).

Thus far, the method for producing a NdFeB system sintered magnet according to the present embodiment has been outlined. Additionally, an aging treatment may be performed after the grain boundary diffusion treatment, as needed.

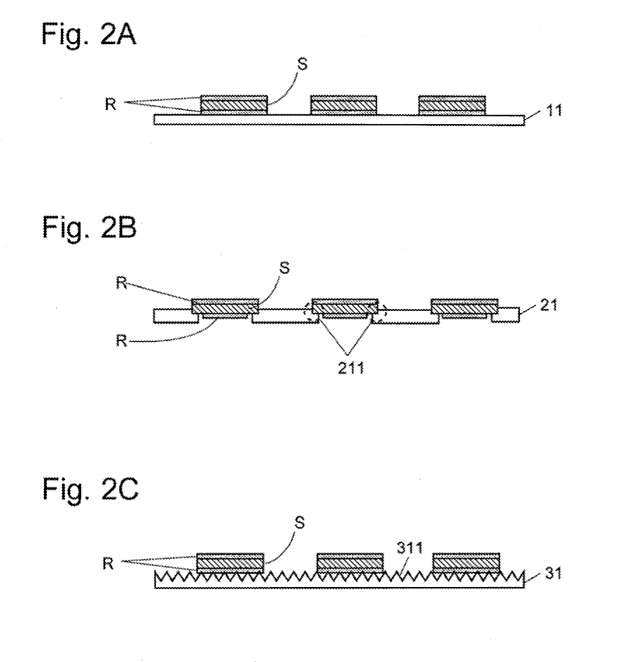

The method for producing a NdFeB system sintered magnet according to the present embodiment is hereinafter compared with conventional methods. Imagine the case where a coating material R is applied to the upper and lower surfaces of a base material S, as shown in FIG. 1A-1D. FIGS. 2A-2C show three conventional examples: (a) the base material S is directly placed on the tray 11 (FIG. 2A); (b) openings, each of which has substantially the same shape as the base material, are formed in the tray 21, with a step-like holding portion 211 formed at the edge of each opening, whereby the base material S is supported only at the ends of its lower surface (FIG. 28); and (c) pointed support portions 311 are formed on the tray 31 to minimize the contact area between the tray 31 and the base material S (FIG. 2C).

Among these examples, method (a) has the following problems: (i) the coating material R on the lower surface of the base material S sticks to the tray 11 during the heat treatment, whereby the use efficiency of the coating material R is lowered, and (ii) the coating material R sticking to the tray 11 adheres to this tray due to the heat treatment.

Method (b) has the following problems: (i) the provision of the holding portion 211 increases the manufacturing cost of the tray 21; (ii) the additional task of placing the base material S in the holding portion 211 is required: (iii) the shape of the holding portion 211 must be changed according to the shape, size or other properties of the base material S; and (iv) it is difficult to apply the coating material R to the ends of the lower surface of the base material S.

Method (c) has the following problems: (i) the provision of the support portions 311 increases the manufacturing cost of the tray 31; (ii) despite the minimized contact area, a certain amount of coating material R sticks to the support portions 311; and (iii) the task of removing the adhered coating material R from the tray 31 is more cumbersome than in the case of normal trays.

By contrast, the method according to the present embodiment has the following advantages: (i) the task can be quickly completed, since what is necessary is to simply cover the base material S with the sheets 10 to which the coating material R has been previously applied; (ii) the coating material R is prevented from sticking to the tray 11; and (iii) the tray 11 can be inexpensively manufactured since it is unnecessary to provide such holding or support portions as used in method (b) or (c).

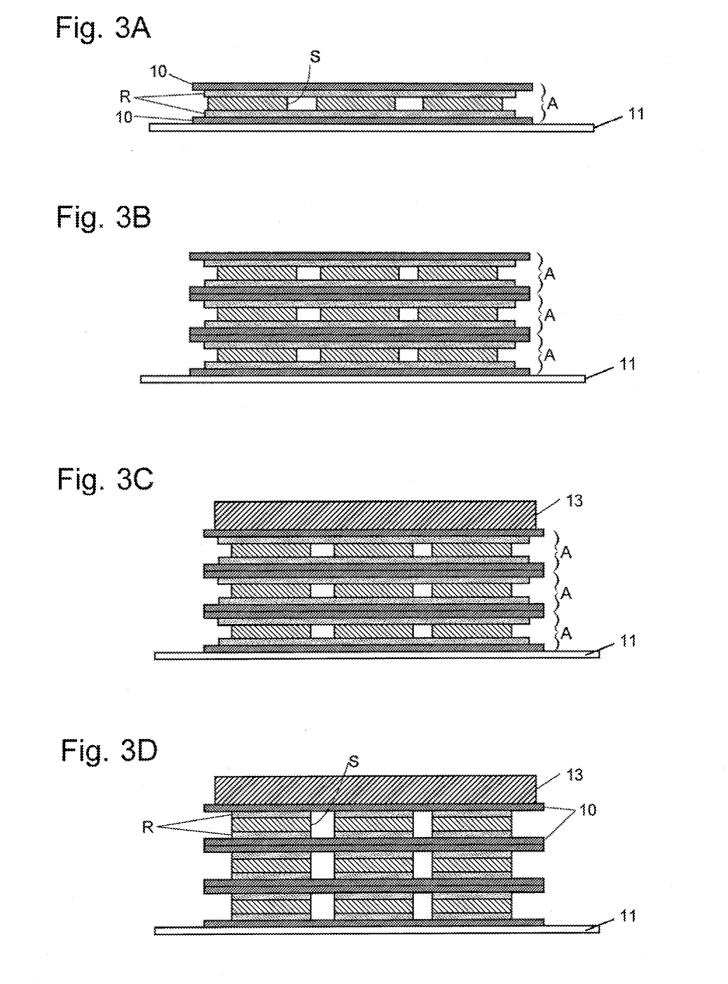

In the method according to the present embodiment, as shown in FIG. 3A, it is possible to entirely cover the surfaces on the same side of a plurality of horizontally arranged base materials S with one sheet 10 to which the coating material R has been applied (with a total of two sheets 10 on the upper and lower surfaces of the base materials S). The set of base materials S sandwiched between the two sheets 10 with the coating material R applied as shown in FIG. 3A (see the numeral “A” in FIG. 3A) can be vertically stacked (FIG. 3B). In the conventional methods (a)-(c), forming a vertical stack requires the same number of trays as the stack layers, and furthermore, care must be taken so that the coating material R on the upper surfaces of the base materials will not come in contact with the lower surface of the tray located just above. The method according to the present embodiment facilitates the vertical stacking and hence is suitable for mass production.

Thus, the method for producing a NdFeB system sintered magnet using a grain boundary diffusion method according to the present embodiment is suitable for cost reduction, high-speed processing and mass production.

Depending on the viscosity of the coating material R, the sheet 10 may be detached from the base material S during the grain boundary diffusion treatment. To prevent this situation, as shown in FIG. 3C, it is preferable to put a weight 13 on top of the upper sheet 10 on the highest level of the stack. The gravity acting on the weight 13 and/or the base materials S makes the upper and lower sheets 10 naturally come in tight contact with the intermediate base material S on every level of the stack during the grain boundary diffusion treatment. Instead of the weight 13 used in the method of FIG. 3(c), a press cylinder or similar mechanical pressure-applying device may be used as the means for increasing the degree of contact between the sheet 10 and the base material S.

To reduce the amount of the coating material R used, the application area of the coating material R on the sheet 10 may be limited to specific areas at which the base materials S are to be placed (FIG. 3D). In this case, the application areas of the coating material R on the upper and lower sheets 10 on both sides of the base material S must be set so that the application areas directly face the upper and lower surfaces of the base materials S.

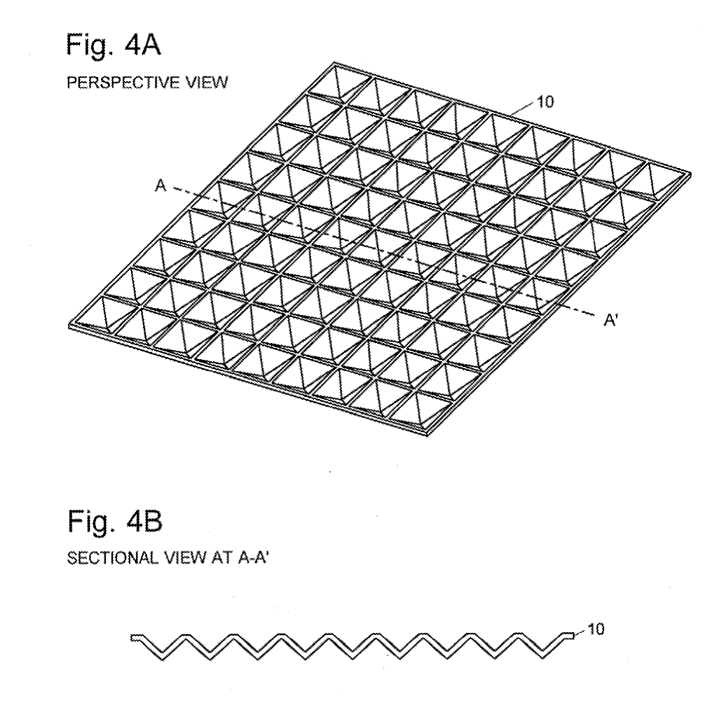

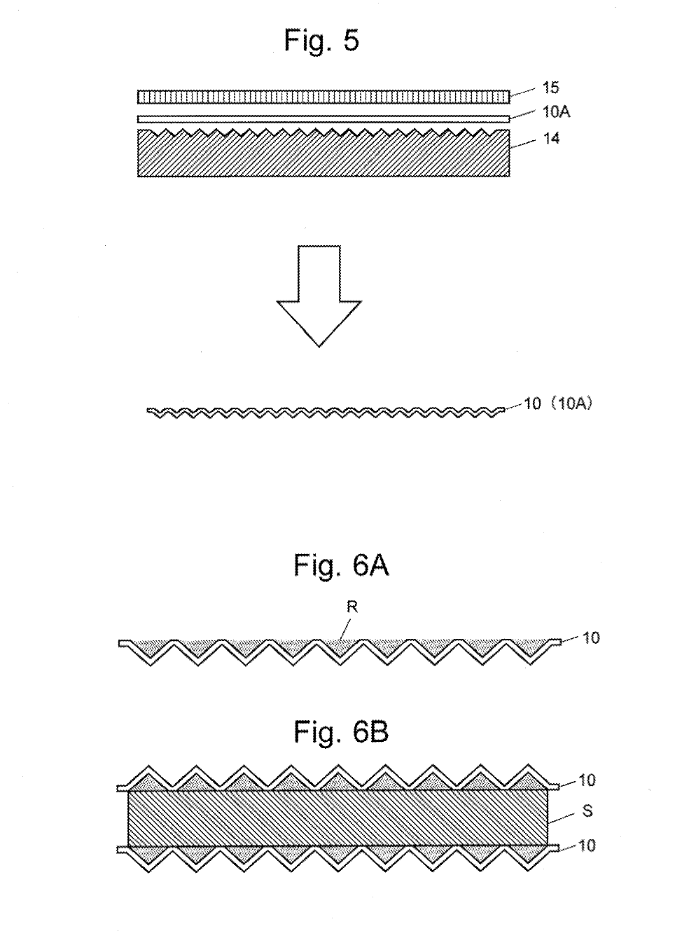

A graphite sheet can be used as the sheet 10. Preferably, the sheet 10 should have a concavo-convex shape, as shown in FIGS. 4A and 4B. Such a sheet 10 can be obtained, as shown in FIG. 5, by putting a graphite sheet 10A on a press die 14, covering the graphite sheet 10A with a rubber sheet 15 and pressing them together.

Forming the concavo-convex shape in the sheet 10 produces the following advantages:

The first advantages is that, by fully applying the coating material R and leveling it with the application surface of the sheet 10 as shown in FIG. 6A, the amount of material R can be easily adjusted to the quantity which is determined by the number and capacity of the hollow portions formed on the application surface of the sheet 10. If a plurality of the kinds of press dies 14 are previously provided, the amount of material to be applied to the base material S can be easily varied by replacing the press die 14 with another one and producing a new sheet 10. An unusably worn-out sheet 10 can be easily and inexpensively replaced.

The second advantage is that, when the contact between the base material S and the sheet 10 is adequately tight, the surface of the base material S serves as a lid of the hollow portions of the sheet 10 and checks the leakage of the coating material R held in the hollow portions (FIG. 6B). This prevents the coating material R from being unevenly distributed on the application target surface of the base material S.

The aforementioned are the advantages of the method according to the present embodiment over the conventional methods in terms of the production process. The advantage of the method according to the present embodiment also appears in the magnetic properties of the produced magnet. Table 1 shows magnetic properties of sintered magnets produced by the method according to the present embodiment. For comparison, the table also shows magnetic properties of sintered magnets produced by performing a grain boundary diffusion treatment on a base material S placed as shown in FIG. 2C.

TABLE 1

| Sample | | | Br | Js | HcB | HcJ | BHMax | Br/Js | Hk | SQ |
|---|---|---|---|---|---|---|---|---|---|---|
| Name | Sheet | Aging | (G) | (G) | (Oe) | (Oe) | (MGOe) | (%) | (Oe) | (%) |
| Base | | | 13840 | 14436 | 13364 | 18518 | 46.41 | 95.9 | 17551 | 94.8 |
| Material S1 | | | | | | | | | | |
| Comparative | No | No | 13386 | 14262 | 12959 | 31502 | 43.78 | 93.9 | 27688 | 87.9 |
| Example 1 | | | | | | | | | | |
| Comparative | No | Yes | 13286 | 14178 | 12851 | 31107 | 42.94 | 93.7 | 28784 | 92.5 |
| Example 2 | | | | | | | | | | |
| Present | Yes | No | 13694 | 14302 | 13328 | 30890 | 46.16 | 95.7 | 29606 | 95.8 |
| Example 1 | | | | | | | | | | |
| Present | Yes | No | 13771 | 14413 | 13385 | 30129 | 46.62 | 95.5 | 28263 | 93.8 |
| Example 2 | | | | | | | | | | |
| Present | Yes | Yes | 13755 | 14350 | 13379 | 30965 | 46.24 | 95.9 | 30021 | 96.9 |
| Example 3 | | | | | | | | | | |
| Present | Yes | Yes | 13758 | 14399 | 13390 | 30400 | 46.23 | 95.6 | 29327 | 96.5 |
| Example 4 | | | | | | | | | | |

In Table 1, Bᵣ is the residual magnetic flux density (the magnitude of the magnetization J or magnetic flux B at the point on the magnetization curve (J-H curve) or demagnetization curve (B-H curve) where the magnetic field is H=0), J, is the saturation magnetization (the maximum value of the magnetization J). H_{cB} is the coercive force defined by the demagnetization curve, H_{cJ} is the coercive force defined by the magnetization curve, (BH)ₘₐₓ is the maximum energy product (the maximum value of the product of the magnetic flux density B and the magnetic field H on the demagnetization curve), Bᵣ/Jₛ is the degree of orientation, H_{K} is the value of the magnetic field H at the point where the magnetization J is 90% of the residual magnetic flux density Bᵣ, and SQ is the squareness (H_{K}/H_{eJ}). Larger values of these properties mean better magnetic characteristics.

The base material S1 in Table 1 is a NdFeB system sintered magnet measuring 7 mm in length, 7 mm in width and 4 mm in thickness, with the magnetization direction coinciding with the thickness direction, which was used as the base material for Comparative Examples and Present Examples shown in Table 1. The magnets of Comparative Examples 1 and 2 were produced by performing a grain boundary diffusion treatment on the base material S1 placed as shown in FIG. 2C. Specifically, the magnet of Comparative Example 1 was produced without performing an aging treatment after the grain boundary diffusion treatment, while that of Comparative Example 2 was produced by performing an aging treatment on the magnet of Comparative Example 1 after the grain boundary diffusion treatment. The magnets of Present Examples 1-4 were produced by the method according to the present embodiment. Specifically, the magnets of Present Examples 1 and 2 were produced without performing an aging treatment after the grain boundary diffusion treatment, while those of Present Examples 3 and 4 were respectively produced by performing an aging treatment on the magnets of Present Examples 1 and 2 after the grain boundary diffusion treatment.

In any of Comparative Examples 1 and 2 as well as Present Examples 1-4, the grain boundary diffusion treatment was performed as follows: The temperature was initially increased from room temperature to 450 degrees Celsius over one hour, after which the heating was continued at 450 degrees Celsius for one hour. Subsequently, the temperature was increased to 875 degrees Celsius over two hours, after which the heating was continued at 875 degrees Celsius for 10 hours. Eventually, the temperature was decreased to room temperature.

The aging treatment in Comparative Example 2 as well as Present Examples 3 and 4 was performed by performing the heating at 480 degree Celsius for 1.5 hours.

The material used as the coating material R was a paste prepared by adding 0.07 g of silicon oil to 10 g of the mixture of the aforementioned TbNiAl alloy powder and silicon grease mixed at a ratio by weight of 80:20. In Comparative Examples 1 and 2, a total of 20 mg of the paste was applied to the 7 mm×7 mm pole faces of the base material S1, with 10 mg on each face. In Present Examples 1-4, a total of 18 mg of the paste was applied to two sheets 10, with 9 mg on each sheet, the two sheets 10 were respectively put on the two pole faces of the base material S1, and a pressure of 2 kgf/cm² (≈20 MPa) was applied to make the sheets 10 come in tight contact with the sample S1 (this pressure is hereinafter called the “contact pressure”). The contact pressure should preferably be within a range from 0.01 kgf/cm² (≈0.1 MPa) to 10 kgf/cm² (≈100 MPa). A contact pressure lower than 0.01 kgf/cm² results in an inadequate contact, while a contact pressure higher than 10 kgf/cm² is unsuitable for mass production.

As the sheet 10, a graphite sheet having a concavo-convex shape as shown in FIGS. 4A and 4B was used.

As the tray 11 for Present Examples or the tray 31 for Comparative Examples, a zirconia plate was used.

As shown in Table 1, all the magnets of Comparative Examples 1 and 2 as well as Present Examples 1-4 had their coercive forces H_{cJ} dramatically improved through the grain boundary diffusion treatment as compared to the base material S1. Their residual magnetic flux densities Bᵣ and the maximum energy products (BH)_{Max} were slightly decreased. However, the magnets of Comparative Examples 1 and 2 showed greater amounts of decrease in these magnetic properties than those of Present Examples 1-4. Such a difference in magnetic properties between Comparative Examples and Present Examples is probably due to the amount of coating material R used.

The magnets of Present Examples 1-4 had higher levels of squareness SQ than those of Comparative Examples 1 and 2. As explained earlier, a NdFeB system sintered magnet must have a high coercive force H_{eJ}, a high maximum energy product (BH)ₘₐₓ and a high squareness ratio SQ when applied in such products as voice coil motors used in hard disks and other apparatuses, driving motors for hybrid or electric cars, battery-assisted bicycle motors, industrial motors, high-grade speakers, headphones, or permanent magnetic resonance imaging systems. The result shown in Table 1 demonstrates that the method for producing a NdFeB system sintered magnet according to the present embodiment is suitable for producing sintered magnets with high squareness.

It can also be understood from Table 1 that the squareness SQ can be further improved by performing the aging treatment.

Another experiment was performed, in which a paste prepared by adding 0.03 g of silicon oil to 10 g of the mixture of the aforementioned TbNiAl alloy powder and silicon grease mixed at a ratio by weight of 80:20 was used as the coating material R. Table 2 shows the result of this experiment. The paste used in the experiment of Table 2 has a higher level of viscosity than the paste used in the experiment of Table 1.

The base material S2 in Table 2 is a NdFeB system sintered magnet measuring 7 mm in length, 7 mm in width and 4 mm in thickness, which was used as the base material for producing the magnets of Comparative Examples 3-6 and Present Examples 5-8 shown in Table 2 by a grain boundary diffusion treatment. The amount of coating material used for Comparative Examples 3-6 was 10 mg×2=20 mg, while the amount of coating material used for Present Examples 5-8 was 7 mg×2=14 mg. The magnets of Comparative Examples 3 and 4 as well as Present Examples 5 and 6 were produced without performing an aging treatment after the grain boundary diffusion treatment. The magnets of Comparative Examples 5 and 6 as well as Present Examples 7 and 8 were respectively pmduced by performing an aging treatment on the magnets of Comparative Examples 3 and 4 as well as Present Examples S and 6 after the grain boundary diffusion treatment. The conditions of the grain boundary diffusion treatment, the aging treatment, the contact pressure, the sheet and the trays used in the experiment of Table 2 were the same as those used in the experiment of Table 1.

TABLE 2

| Sample | | | Br | Js | HcB | HcJ | BHMax | Br/Js | Hk | SQ |
|---|---|---|---|---|---|---|---|---|---|---|
| Name | Sheet | Aging | (G) | (G) | (Oe) | (Oe) | (MGOe) | (%) | (Oe) | (%) |
| Base | | | 13765 | 14520 | 13269 | 18800 | 45.77 | 94.8 | 17665 | 94.0 |
| Material S2 | | | | | | | | | | |
| Comparative | No | No | 13548 | 14236 | 13167 | 31119 | 45.07 | 95.2 | 29108 | 93.5 |
| Example 3 | | | | | | | | | | |
| Comparative | No | No | 13579 | 14191 | 13223 | 31073 | 45.39 | 95.7 | 29284 | 94.2 |
| Example 4 | | | | | | | | | | |
| Comparative | No | Yes | 13490 | 14232 | 13095 | 30950 | 44.40 | 94.8 | 29696 | 94.5 |
| Example 5 | | | | | | | | | | |
| Comparative | No | Yes | 13568 | 14250 | 13189 | 30978 | 45.01 | 95.2 | 29879 | 94.9 |
| Example 6 | | | | | | | | | | |
| Present | Yes | No | 13882 | 14547 | 13484 | 23505 | 47.22 | 95.4 | 21359 | 90.9 |
| Example 5 | | | | | | | | | | |
| Present | Yes | No | 13734 | 14448 | 13306 | 21649 | 46.05 | 95.1 | 19939 | 92.1 |
| Example 6 | | | | | | | | | | |
| Present | Yes | Yes | 14023 | 14675 | 13614 | 23453 | 47.97 | 95.6 | 21915 | 93.4 |
| Example 7 | | | | | | | | | | |
| Present | Yes | Yes | 13672 | 14460 | 13246 | 22573 | 45.48 | 94.6 | 21271 | 94.2 |
| Example 8 | | | | | | | | | | |

As shown in Table 2, the coercive forces H_{cJ} of the magnets of Present Examples 5-8 were lower than those of the magnets of Comparative Examples 3-6. This is due to the fact that the sheets 10 were detached from the base material S during the grain boundary diffusion treatment. In the method for producing a NdFeB system sintered magnet according to the present embodiment, in order to prevent the sheets 10 from being detached from the base material S, it is preferable to appropriately set the contact pressure for making the sheets 10 in tight contact with the base material S, to determine whether or not a weight 13 as shown in FIGS. 3C and 3D is necessary, and to optimize the mass of the weight 13, according to the paste viscosity.

Table 3 shows magnetic properties of magnets produced under the same experimental conditions as in Present Examples 5-8 in Table 2, using a weight 13 put on the base materials S2, with the sheet 10 in between, for applying a pressure of 36 g per base material (7-mm square area). In Table 3, the magnets of Present Examples 9-11 were produced without performing an aging treatment after the grain boundary diffusion treatment, while those of Present Examples 12-14 were produced by performing an aging treatment on the magnets of Present Examples 9-11 after the grain boundary dilffusion treatment.

TABLE 3

| Sample | | | Br | Js | HcB | HcJ | BHMax | Br/Js | Hk | SQ |
|---|---|---|---|---|---|---|---|---|---|---|
| Name | Sheet | Aging | (G) | (G) | (Oe) | (Oe) | (MGOe) | (%) | (Oe) | (%) |
| Present | Yes | No | 13741 | 14363 | 13383 | 30095 | 46.44 | 95.7 | 28898 | 96.0 |
| Example 9 | | | | | | | | | | |
| Present | Yes | No | 13622 | 14439 | 13199 | 29001 | 45.38 | 94.3 | 24540 | 84.6 |
| Example 10 | | | | | | | | | | |
| Present | Yes | No | 13732 | 14463 | 13318 | 28529 | 46.21 | 94.9 | 25516 | 89.4 |
| Example 11 | | | | | | | | | | |
| Present | Yes | Yes | 13785 | 14450 | 13396 | 30201 | 46.40 | 95.4 | 29390 | 97.3 |
| Example 12 | | | | | | | | | | |
| Present | Yes | Yes | 13695 | 14471 | 13252 | 29481 | 45.56 | 94.6 | 28143 | 95.5 |
| Example 13 | | | | | | | | | | |
| Present | Yes | Yes | 13727 | 14423 | 13326 | 29190 | 45.94 | 95.2 | 28089 | 96.2 |
| Example 14 | | | | | | | | | | |

In the experiment of Table 3, by putting the weight 13 on the base material S2 with the sheet 10 in between, the sheet 10 could be prevented from being detached from the base material S2 and the two elements were maintained in contact with each other throughout the grain boundary diffusion treatment. As a result, the coercive forces H_{cJ} dramatically improved, as shown in Table 3. As for the squareness SQ, the values were somewhat low in Present Examples 10 and 11, while the magnets of Present Examples 13 and 14, which were produced by performing the aging treatment on the magnets of Present Examples 10 and 11, achieved excellent results of higher than or equal to 95%. The squareness SQ of the magnet of Present Example 12 was the highest of all the magnets produced in Comparative and Present Examples.

The weight 13 used in the experiment of Table 3 weighed 36 g per base material. Similar results were obtained in the present experiment when the pressure applied in the grain boundary diffusion treatment was equal to or higher than 0.11 MPa (approximately 5 g or greater per base material).

The method for producing a NdFeB system sintered magnet according to the present invention has been described thus far by means of the embodiment. It should be noted that the method according to the present invention is not limited to this embodiment. For example, in the previous embodiment, it is assumed that the coating material R is applied via the sheet to both the upper and lower surfaces of the base material S. In some applications of the produced magnet, the coating material R only needs to be applied to a single surface. Naturally, in such a case, the sheet 10 only needs to be put on a single surface. It is also naturally possible to put the sheet 10 on the side surface of the base material S in addition to the upper and/or lower surface.

### REFERENCE SIGNS LIST

10 . . . Sheet
10A . . . Graphite Sheet
11, 21, 31 . . . Tray
12 . . . Furnace
13 . . . Weight
14 . . . Press Die
15 . . . Rubber Sheet
211 . . . Holding Portion
311 . . . Supporting Portion

1. A method for producing a NdFeB system sintered magnet including a grain boundary diffusion treatment process in which, after a coating material containing a heavy rare-earth element is applied to a base material of a NdFeB system sintered magnet, the base material with the coating material applied is heated so as to diffuse the heavy rare-earth element in the coating material through grain boundaries into the base material, the method comprising steps of:
applying the coating material to a sheet;
making the sheet come in tight contact with the base material in such a manner that the coating material applied to the sheet comes in contact with an application target surface of the base material; and
performing the grain boundary diffusion treatment by heating the base material together with the sheet.

2. The method for producing a NdFeB system sintered magnet according to claim 1, wherein a number of hollow portions are provided on an application surface of the sheet.

3. The method for producing a NdFeB system sintered magnet according to claim 2, wherein the amount of coating material is regulated by adjusting a number and/or depth of the hollow portions.

4. The method for producing a NdFeB system sintered magnet according to claim 1, wherein a graphite sheet is used as the sheet.

5. The method for producing a NdFeB system sintered magnet according to claim 1, wherein the sheet is held in contact with the base material during the grain boundary diffusion treatment.

6. The method for producing a NdFeB system sintered magnet according to claim 5, wherein pressure is applied to the sheet during the grain boundary diffusion treatment so as to increase a degree of contact between the base material and the coating material.

7. The method for producing a NdFeB system sintered magnet according to claim 1, wherein the application target surfaces of a plurality of the base materials are entirely covered with a single sheet.

8. The method for producing a NdFeB system sintered magnet according to claim 1, wherein a plurality of base materials are vertically stacked, with each of the upper and lower surfaces of each base material being covered with the sheet.

9. The method for producing a NdFeB system sintered magnet according to claim 1, wherein an aging treatment is performed after the grain boundary diffusion treatment.

10. The method for producing a NdFeB system sintered magnet according to claim 1, wherein the sheet is made of a material in which the heavy rare-earth element is less diffusive than in the base material.

11. The method for producing a NdFeB system sintered magnet according to claim 1, wherein the sheet is made of a material which does not undergo a chemical or physical change during the grain boundary diffusion treatment.

12. The method for producing a NdFeB system sintered magnet according to claim 1, wherein the sheet is a flexible sheet.
